(19) United States
(12) Patent Application Publication
(10) Pub. No.: US 2021/0404540 A1
(43) Pub. Date: Dec. 30, 2021

(54) CONSTANT-INPUT-TORQUE, CONTINUOUSLY-VARIABLE-SPEED, AUTOMATIC TRANSMISSION USING JUXTAPOSED CONES, AND AN INCLINED PLANE TORQUE COUPLER

(71) Applicant: Larry Ernest Click, Huntington Beach, CA (US)

(72) Inventor: Larry Ernest Click, Huntington Beach, CA (US)

(21) Appl. No.: 16/911,906

(22) Filed: Jun. 25, 2020

(51) Int. Cl. F16H 15/22

(52) U.S. Cl. CPC F16H 15/22

(57) ABSTRACT

This CONSTANT-INPUT-TORQUE, CONTINUOUSLY-VARIABLE-SPEED, AUTOMATIC TRANSMISSION USING JUXTAPOSED CONES, AND AN INCLINED PLANE TORQUE COUPLER (herein: “Transmission”) is a simple, light weight, ‘constant input torque’, infinitely-variable speed, automatic transmission which uses two oppositely oriented (juxtaposed) cones and control mechanisms, appropriately interconnected by a serpentine belt. The output of the Transmission is connected to the useful load for which the Transmission is used. This Transmission has the inherent property that, regardless of the load resistance connected, the torque at the Transmission input remains approximately constant, while output rotational velocity (speed) varies as load increases or decreases.

### FIELD

This application relates to the field of variable-speed transmissions, and specifically, to a ‘constant-input-torque’ transmission which automatically changes the ratio of input shaft rotation speed to output shaft rotation speed, as output resistance is encountered and varies.

### BACKGROUND

Most transmissions used for human powered mobility (such as a bicycle) use a set of fixed gears with a means of manually changing gears on demand. This is efficient and effective, but cumbersome and sometimes unwieldy. Often the human cyclist encounters situations where the gear ratio is inappropriate for the speed—particularly after breaking to a full stop. Subsequently, starting forward mobility is difficult because of the intense force required to rotate the motive mechanism (e.g.: a bicycle drive wheel) because of an improper gear ratio. Additionally, in such situation, the low forward speed makes bicycle control and balancing difficult.

An automatic transmission eliminates all concern regarding determining the proper gear ratio for a specific forward speed, or in the accomplishment of a change in speed, or in anticipation of a change in incline. The overall (e.g.: cycling) experience is improved, simplified and made more enjoyable.

Advantages also occur where the input power source (e.g.: a human or an engine) is of low power, and faces a variable load (such as a propeller, small farm tractor, lawn mower, an electric generator, air compressor, or a variable lifted load).

### SUMMARY

The depicted disclosure describes a ‘constant-input-torque’, automatic, almost infinitely-variable speed transmission.

In this embodiment, an input torque at the input Thrust Assembly Axle is passed through general supports, to a Thrust Assembly.

The Thrust Assembly consists of a Thrust Assembly Plate, a Thrust Assembly Inclined Plane Member, a rotational Thrust Assembly Balance Weight, and a Thrust Assembly Alignment Tab.

The Thrust Assembly is restricted to rotational motion and does not translate.

The Thrust Assembly abuts the Actuator Assembly.

The Actuator Assembly consists of the Actuator Assembly Plate, the Actuator Assembly Inclined Plane Member, and the Actuator Assembly Balance Weight.

The rotating Thrust Assembly Inclined Plane Member places torque on the Actuator Assembly at the Actuator Assembly Inclined Plane Member.

The Thrust Assembly and the Actuator Assembly rotate together around the Actuator Assembly Axle axis and are approximately synchronized.

The Actuator Assembly rotates and translates along the Actuator Assembly Axle axis.

The Actuator Assembly is connected to, and rotates with, the Thrust Cone.

The output, the Thrust Cone and the Drive Cone, and a Ratio Control Rod Pulley are synchronized via a serpentine belt (not shown). Juxtaposed cones and a control mechanism, in conjunction with a serpentine belt, and used as a transmission, collectively are covered by other patents.

Because of the interconnection via the serpentine belt, when there is rotational resistance at the Drive Cone, that resistance is realized at the Thrust Cone. Thus, the Actuator Assembly and the Actuator Assembly Inclined Plane Member resists rotational torque from the Thrust Assembly Inclined Plane Member. When there is a significant torque on the Thrust Assembly and significant torque resistance on the Actuator Assembly Inclined Plane Member, the two inclined planes will slide against each other. Consequently, the Actuator Assembly translates along the Actuator Assembly Axle, via splines on the Actuator Assembly Axle, toward the two juxtaposed cones.

The rotating and translating Actuator Assembly pushes against a non-rotating, but translating, Ratio Control Rod. The Ratio Control Rod is consequently translated toward the two cones.

On the end of the Ratio Control Rod is the Ratio Control Rod Pulley which rotates on an axis parallel to the axes of the two cones.

A serpentine belt (not shown) connects the Ratio Control Rod Pulley, the two cones and the ultimate output mechanism (e.g.: a bicycle rear wheel, propeller or other mechanism).

When the Ratio Control Rod Pulley is forced toward the two cones, the serpentine belt (not shown) around it also moves longitudinally along the two cones. The serpentine belt tightly interconnects (rotationally links) the two cones and the Ratio Control Rod Pulley in a manner preventing slippage between the belt and either of the cones or the Ratio Control Rod Pulley. The serpentine belt remains perpendicular to the axes of the two cones.

Variable input to output rotational ratios are accomplished as the serpentine belt rotates the cones while translating along the cone axes.

A Biasing Member (typically a coil spring) acts to force the Ratio Control Rod and the Actuator Assembly toward the Thrust Assembly, when the torque at the Thrust Assembly is less than the torque at the Actuator Assembly.

### BRIEF DESCRIPTION OF THE DRAWINGS

FIG. 1 Is an isometric drawing of the Transmission mechanism, excluding the serpentine drive belt. It shows all parts described in the detailed description.

FIG. 2 Is an isometric drawing of one embodiment of the Actuator Assembly, which includes the Actuator Assembly Plate, the Actuator Assembly Balance Weight, and the Actuator Assembly Inclined Plane Member, and which shows the eccentricity of the Actuator Assembly Inclined Plane Member and the inclined surface which slides against the Thrust Assembly Inclined Plane Member.

### DETAILED DESCRIPTION

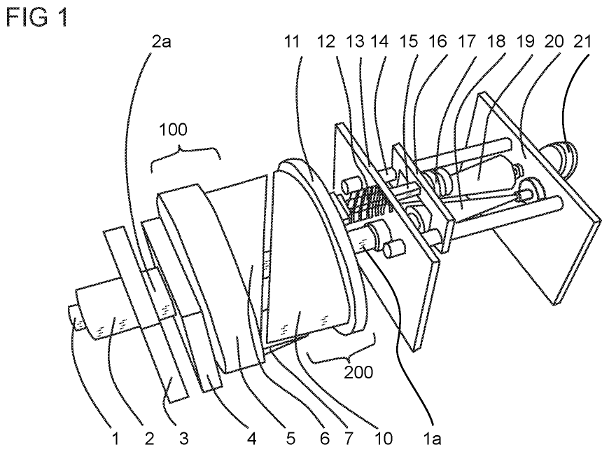

With reference to FIG. 1 A rotational torque is applied via a crank, pulley, or other mechanism, on the Thrust Assembly Axle 2 (and also continued as 2a). The torque is passed through the general Supports 3 and 4 to the Thrust Assembly Plate 5 and the Thrust Assembly Inclined Plane Member 6 and the Thrust Assembly Alignment Tab 7 which freely rotate on the Actuator Assembly Axle 1 axis (and also continued as 1a). The Thrust Assembly Alignment Tab 7 ensures proper rotational positioning between the Thrust Assembly 100 and the Actuator Assembly 200.

When greater resistance than normal is encountered in the drive train (at the Drive Cone Pulley 21 which is connected to, and rotates with, the Drive Cone 19; to overcome initial inertia when accelerating, or when encountering increased system load) the Thrust Assembly Inclined Plane Member 6 forces the Actuator Assembly Inclined Plane Member 10 to slide along the inclined mating plane between Thrust Assembly Inclined Plane Member 6 and Actuator Assembly Inclined Plane Member 10. This, consequently, forces a longitudinal translation of the rotating Actuator Assembly Inclined Plane Member 10 and the Actuator Assembly Plate 11 toward the two juxtaposed cones 18 and 19.

The Actuator Assembly Inclined Plane Member 10 and the Actuator Assembly Plate 11, are free to translate along the Actuator Assembly Axle 1 axis, and also rotate with the Actuator Assembly Axle 1 axis, at the same rotational speed as the thrust cone 18, and generally at the same rotational speed with the Thrust Assembly Plate 5 and the Thrust Assembly Inclined Plane Member 6.

The rotating Actuator Assembly Plate 11 pushes against a non-rotating Ratio Control Rod 15. Limited by the Support 13 and supported by the Ratio Control Rod Support 16 and the Ratio Control Rod Support Slide Guide 14 (of which there are two guides, one on each side of the Ratio Control Rod Support 16), the Ratio Control Rod 15 is consequently translated toward the two cones 18 and 19.

Connected near the end of the Ratio Control Rod 15 is the Ratio Control Rod Pulley 17 which rotates on an axis parallel to the rotational axes of the two cones 18 and 19.

A Biasing Member 12 (typically a coil spring) acts to force the Ratio Control Rod 15, the Actuator Assembly Plate 11 and the Actuator Assembly Inclined Plane Member 10 toward the Thrust Assembly Plate 5 when torque at the Thrust Assembly 100 is reduced.

The Drive Cone 19 is supported by the Supports 13 and 20.

The Thrust Cone 18 is attached to, and coaxial with, and rotates with, the Actuator Assembly Axle 1 and the Actuator Assembly Plate 11.

The Thrust Cone 18 is supported by the general supports 13 and 20.

In this embodiment the Thrust Assembly Inclined Plane Member 6 is shown as an exponential curved solid extending from the approximate center of the Thrust Assembly Plate 5 to the approximate outer edge of the Thrust Assembly Plate 5. However, almost any other geometric solid would also function appropriately for the Thrust Assembly Inclined Plane Member 6, providing there is a mating surface between Actuator Assembly Inclined Plane Member 10 and the Thrust Assembly Inclined Plane Member 6.

In this embodiment, the Ratio Control Rod Support Slide Guides 14 are shown as circular rods, but any cross-sectional shape may be used.

In this embodiment the Ratio Control Rod 15 is shown as a “T-ended” square rod, but any cross-sectional shape may be used. Additionally, in other possible embodiments, the end abutting the Actuator Assembly Plate 11 may have a rolling mechanism (such as a captive ball(s) or a rolling wheel) to reduce friction between the Actuator Assembly Plate 11 and the Ratio Control Rod 15.

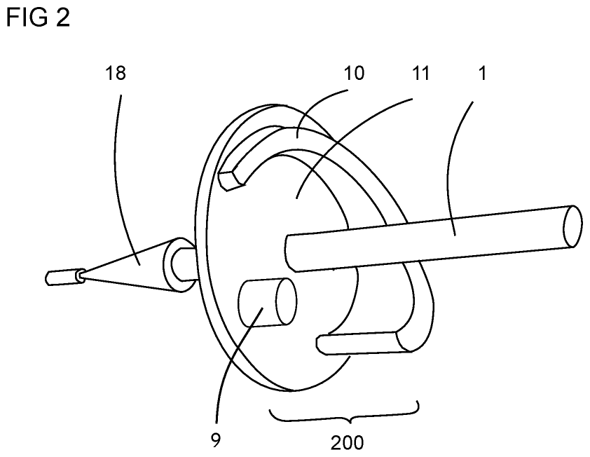

With reference to FIG. 2 This embodiment is an isometric drawing of the Actuator Assembly 200 consisting of the Actuator Assembly Inclined Plane Member 10, the Actuator Assembly Balance Weight 9, and the Actuator Assembly Plate 11, together with the Thrust Cone 18, arranged on, concentric with, rotating with, and capable of translating, via splines, along the Actuator Assembly Axle 1.

In this embodiment the Actuator Assembly Inclined Plane Member 10 is shown as a curved solid extending approximately one-half way around the Actuator Assembly Plate 11 at the approximate outer edge of the Actuator Assembly Plate 11, declining in height along its length. However, almost any other geometric solid would also function appropriately for the Actuator Assembly Inclined Plane Member 10, providing there is a smooth, inclined-plane, mating surface between the Actuator Assembly Inclined Plane Member 10 and the Thrust Assembly Inclined Plane Member 6.

Various nuts, washers, and C-rings (not shown) retain members in their appropriate positions, together with bearings and harm-preventing shielding are additional members of the Transmission, but are not substantial to the description of the Transmission device functionality.

I claim:

1. The design of a constant-input-torque, infinitely-variable-drive-ratio, automatic transmission mechanism (herein: “Transmission”) for accomplishing automatically-adjustable rotational output variability of a juxtaposed-cone-based transmission via a constant-input torque and using a device comprised of a/an: Thrust Assembly; an Actuator Assembly; a Ratio Control Rod with pulley; and a Biasing Member; and used in combination with two juxtaposed cones and one interconnecting serpentine belt; together with supports as necessary to affix the Transmission in position, as desired.

2. The Transmission mechanism of claim 1, wherein the rotating, but not translating, Thrust Assembly transmits torque via an inclined plane to the surface-mated, and approximately-rotationally-synchronized, rotating Actuator Assembly.

3. The Transmission mechanism of claim 1, wherein the rotating Actuator Assembly receives the transmitted torque via an inclined plane, and, when sufficient torque is applied to overcome the resistance of the Biasing Member and the load, the Actuator Assembly is translated axially, toward the juxtaposed-cone combination.

4. The Transmission mechanism of claim 1, wherein the Actuator Assembly linearly translates a Ratio Control Rod, and an affixed Ratio Control Rod Pulley parallel to the axes of the juxtaposed-cone combination. The Ratio Control Rod Pulley moves a serpentine belt which connects the Ratio Control Rod Pulley, the Thrust Cone, and the Drive Cone. The Drive Cone is firmly affixed to, and rotates, the Drive Cone Pulley. The Drive Cone Pulley connects to the desired output [e.g.: wheel, propeller, etc.] via a belt, chain or similar mechanism; AND where the serpentine belt affects the opposing-diameter-based ratio of the input (Thrust Cone) RPM to the output (Drive Cone) RPM. Note: The functional details regarding the varying ratio of input RPM to corresponding output RPM of juxtaposed-cone-based transmissions is explained by other patents (e.g.: U.S. Pat. No. 7,803,077 B1).
